(19) United States
(12) Patent Application Publication
(10) Pub. No.: US 2023/0347439 A1
(43) Pub. Date: Nov. 2, 2023

(54) METHOD AND WELDING DEVICE FOR CONTACTLESSLY STRIKING AN ARC

(71) Applicant: Fronius International GmbH, Pettenbach (AT)

(72) Inventors: Martin WILLINGER, Wels-Thalheim (AT); Peter LATTNER, Wels-Thalheim (AT)

(73) Assignee: Fronius International GmbH, Pettenbach (AT)

(21) Appl. No.: 18/020,719

(22) PCT Filed: Aug. 11, 2021
(86) PCT No.: PCT/EP2021/072371

§ 371 Date: Feb. 10, 2023

(30) Foreign Application Priority Data
Aug. 13, 2020 (EP) 20190851.4

(51) Int. Cl. B23K 9/067; B23K 9/095

(52) U.S. Cl. CPC B23K 9/0672; B23K 9/0956

(57) ABSTRACT

A method and a welding device for contactlessly striking an arc between an electrode of a welding head and a material surface of a workpiece. A first ignition voltage pulse with a first or second polarity is generated between the electrode and the material surface. After being struck and, where applicable, after a polarity reversal, the arc is maintained with the second polarity or with an alternating polarity. In the event of an ignition failure, after the first ignition voltage pulse, a sequence of ignition voltage pulses is generated according to a sequence pattern until successful striking of the arc. The sequence pattern includes ignition voltage pulses with the first polarity and ignition voltage pulses with the second polarity, and an ignition pause is provided between ignition voltage pulses with the first polarity and ignition voltage pulses with the second polarity.

The present disclosure relates to a welding device and a method for contactlessly striking an arc between an electrode of a welding head and a material surface of a workpiece for a welding process.

Specifically, DC welding processes, in which a welding voltage with only one polarity is used during a welding process, and AC welding processes, in which the polarity of the welding voltage changes during a welding process, are considered in the course of the following explanations.

In both DC welding processes and AC welding processes, an ignition voltage pulse is generated at the start of the welding process, as part of an ignition process (initial striking), in order to initially generate the arc. In the case of AC welding processes, ignition voltage pulses (zero-cross striking) are also generated when the polarity of the welding voltage changes during the welding process, i.e., with the zero-crossing, in order to maintain the arc, i.e., to prevent the arc from breaking, which also corresponds to an ignition process.

For contactless striking of an arc between an electrode of a welding device and a workpiece, an ignition voltage pulse can be applied between the electrode and the workpiece, which ionizes the region between the electrode and the workpiece so that the arc strikes in the ionized region. If no striking occurs (i.e., no arc is formed), another ignition voltage pulse with the same polarity is applied after a short pause. As soon as the arc has been struck, a welding voltage is applied, with which the arc is maintained during welding.

In DC welding processes (especially for welding steel and high-alloy steel), it is possible to start with a negative ignition voltage pulse (“striking at the negative pole”), since welding also takes place with a negative welding current.

Some more modern welding devices also offer the option of starting striking with a positive ignition voltage pulse (“striking at the positive pole”). Since welding is usually to be performed with a negative welding current, a polarity reversal takes place after the striking. In the case of a tungsten electrode, for example, striking at the positive pole can improve the ignition behavior and arc stability when starting the weld. Striking at the positive pole leads to increased stress on the electrode.

However, striking at the positive pole can be more difficult with smooth, polished surfaces, and it is possible that the arc that has already been struck will go out when the polarity is reversed, or that the arc will generally not strike.

In practice, the user must select the desired ignition setting or ignition polarity, and they must change it if the selected setting is not suitable for the task at hand, which becomes unpleasantly noticeable through frequent ignition misfires. This can also have a negative effect on the quality of the weld seam. Finding the suitable setting is often a matter of trial and error, since the user is usually not aware of why (or how exactly) the two ignition methods differ from each other, or which parameters are important, and why one or the other ignition method works better in a given case. It is also possible that parameters change during welding, e.g., if the same workpiece is to be welded over a weld seam that has already been made, and this weld seam now has a lower surface roughness than the workpiece, for example, and the selected ignition method is therefore suddenly less reliable.

The optimum ignition settings or the most suitable ignition polarity depend upon numerous material factors, such as surface roughness, chemical composition, crystallographic properties, grain size, coatings, etc. In particular, a pre-existing weld or other, for example local, temperature treatment of a given material surface can change, for example, grain sizes and crystallographic properties and consequently the ignition behavior. Furthermore, segregations and separations of a, for example, solidified melt (melt material) can also lead to different ignition behavior. It is also known that pores, inclusions, bubbles, slag residues, and other surface irregularities can influence the ignition behavior. Furthermore, oxide layers on the surface produced by heat treatment, but also a previous introduction of, for example, nitrogen or carbon into the surface, as produced, for example, by surface processes such as nitriding, carbonitriding, plasma nitriding, etc., can change the ignition behavior. Likewise, for example, local mechanical surface treatments such as milling, grinding, polishing, lapping, etc., or mechanical surface treatments in general, lead to altered ignition behavior. Any contamination or contamination layers on the surface, or residues of cleaning agents or atmospheric absorption layers formed over time, or any reaction layers formed over time due to the influence of the atmosphere can also have an influence on the ignition behavior of the arc. It is therefore not always clear, even to experienced users, which settings and which preferred polarity are optimal for a given task. Furthermore, even if not always necessarily visible visually to the welder, surfaces can exhibit such inhomogeneous ignition behavior that the ignition setting has to be individually adjusted for each application.

It is an object of the present disclosure to provide devices and methods with which the ignition reliability during contactless striking of the arc is improved.

According to one aspect, the present disclosure relates to a method for contactlessly striking an arc between an electrode of a welding head and a material surface of a workpiece. A first ignition voltage pulse with a first or second polarity is generated between the electrode and the material surface, wherein, after being struck and, where applicable, after a polarity reversal, the arc is maintained with the second polarity or with an alternating polarity, wherein, in the event of an ignition failure, after the first ignition voltage pulse, a sequence of ignition voltage pulses is generated according to a sequence pattern until successful striking of the arc, wherein the sequence pattern comprises ignition voltage pulses with the first polarity and ignition voltage pulses with the second polarity, and wherein an ignition pause is provided between ignition voltage pulses with the first polarity and the second polarity. As a result, the arc can always be ignited using the optimal ignition method, without the need for operator intervention. Ignition misfires are avoided. The sequence pattern is preferably defined by a regularly repeating pattern of ignition voltage pulses of different polarity.

One embodiment according to the present disclosure would also include the fact that the magnitude of the ignition voltage or ignition current of the first polarity differs from the magnitude of the ignition voltage or ignition current of the second polarity. A further embodiment according to the present disclosure would likewise include the fact that the time duration of the ignition voltage or ignition current of the first polarity differs from the time duration of the ignition voltage or ignition current of the second polarity. Where applicable, successive ignition voltage pulses of the same polarity may also differ from each other in terms of magnitude and/or length.

The ignition pause between the ignition pulses can be system-related and/or caused by the implementation of the welding device and/or an ignition pause requested by the user. Ignition pauses provided between ignition pulses of different polarity can be used here to check whether an arc has already been struck.

The method for contactlessly striking an arc can also be referred to as an ignition process. A welding process comprises ignition processes in which the arc is struck, welding processes in which the arc burns, and idle phases in which no arc burns, or none is even struck. In the case of AC welding processes, an ignition process can also take place during the welding process, at a zero-crossing of the welding current.

The term “polarity” refers in each case to the polarity of the electrode. The first polarity can be either a positive or a negative polarity of the electrode; the second polarity is defined by the—compared to the first polarity—reversed polarity. The choice of polarity depends in particular upon the material to be welded, wherein most materials are welded with a negatively-polarized electrode. In that case, the second polarity corresponds to the negative polarity. However, there are also materials—especially aluminum and its alloys—which can be welded only to a limited extent at the negative pole. In this case, welding must be carried out either at the negative pole with an expensive shielding gas such as helium, or at the positive pole with argon or a helium-argon gas mixture, or with alternating current (AC welding process).

In an advantageous manner, the sequence pattern can be defined by an alternating sequence of an ignition voltage pulse with the first polarity followed by an ignition voltage pulse with the second polarity, or vice versa. Such a sequence is particularly optimal if a preferred ignition polarity is not known.

In a further advantageous embodiment, the sequence pattern can be defined by a first fixed or variable number of ignition voltage pulses with the first polarity followed by a second fixed or variable number of successive ignition voltage pulses with the second polarity, or vice versa. This can be advantageous, for example, if a preferred polarity is known, and striking is to be attempted with this polarity first. Only if striking has not occurred after a number of attempts a change to the other polarity is made. The first and second numbers can be the same or different. The sequence defined in this way is repeated until the arc is struck or until a specified maximum length is reached.

When the arc is struck following an ignition voltage pulse with the first polarity, the arc can be maintained preferably for a warm-up period at the first polarity, after which the polarity is reversed to the second polarity. The warm-up period increases the stability of the arc, which facilitates the polarity reversal.

Advantageously, if the arc is extinguished during the polarity reversal, the previously started sequence of ignition voltage pulses can be continued in accordance with the sequence pattern. This can improve the ignition behavior if the arc strikes with the first polarity during the ignition voltage pulse, but goes out again when the polarity is reversed. Alternatively, the sequence of ignition voltage pulses can be restarted according to the same or a different sequence pattern, after the arc is extinguished when the polarity is reversed.

Advantageously, at least one parameter that evaluates a quality and/or an ignition behavior of the sequence pattern used can be determined, wherein, where applicable, the determined parameter is stored and/or is displayed via a user interface or via an input and output unit. The parameter can be any measured or derived variable which permits an evaluation of the quality and/or the ignition behavior. For example, the parameter may represent a number of unsuccessful ignition attempts on one or both polarities. Where applicable, the parameter can represent a certain property of a sequence pattern and/or of an ignition pulse (especially its duration and/or voltage) with which striking was successful or unsuccessful. However, numerous other measured and/or determinable values can also be used as a parameter.

In a further advantageous embodiment, an alternative sequence pattern can be automatically selected if the parameter falls below or exceeds or reaches a previously defined limit value. This allows the method to be automatically improved if the striking does not function optimally in a particular application.

Advantageously, the alternative sequence pattern is either randomly selected from several sequence patterns or is generated with the aid of an optionally adaptive algorithm. The adaptive algorithm can use artificial intelligence methods (for example, using neural networks) or “classical” programming—for example, based upon characteristic curves or characteristic maps. This allows, for example, the ignition behavior of an individual welding device executing the method in question to be automatically adapted optimally to the ambient and welding conditions preferred and/or required by the user. Where appropriate, the adaptive algorithm may also use any available information about environmental conditions and/or material parameters and/or welding parameters to optimize the sequence pattern.

The welding process may be an AC welding process. This means that, after contactlessly striking the arc, a welding current with alternating polarity flows during the welding process.

However, the welding process may also be a DC welding process. This means that, after contactlessly striking the arc, a welding current with one polarity flows during the welding process, wherein the welding current can also be pulsed.

If the welding process is an AC welding process, the contactless striking of the arc can take place during the welding process. This means that the contactless striking takes place when the polarity changes, i.e., with the zero-crossing of the welding current, thus preventing the arc from breaking off.

However, the contactless striking of the arc can also occur at the start of the welding process. The welding process is thus initiated by an ignition process. This can be used for AC welding processes, as well as for DC welding processes.

Preferably, the ignition voltage pulses are subjected to a polarity reversal at least twice in the sequence pattern. This means that the sequence pattern either comprises at least one ignition voltage pulse with a first polarity, followed by at least one ignition voltage pulse with a second polarity, followed by at least one ignition voltage pulse with a first polarity, or comprises at least one ignition voltage pulse with a second polarity, followed by at least one ignition voltage pulse with a first polarity, followed by at least one ignition voltage pulse with a second polarity. Preferably, in this sense, more than two polarity changes can also be made.

In a further aspect, the present disclosure relates to a welding device having a welding head on which an electrode is provided, wherein the electrode is connected to a supply unit by which a voltage can be applied in controlled fashion between the electrode and a material surface of a workpiece. The supply unit is configured, for contactless striking of an arc between the electrode and the material surface, to generate a first ignition voltage pulse with a first or second polarity and to maintain the arc with the second polarity after having been struck and, where applicable, after a polarity reversal, wherein the supply unit is further configured, in the event of an ignition failure, after the first ignition voltage pulse until successful striking of the arc, to generate a sequence of ignition voltage pulses according to a sequence pattern, wherein the sequence pattern comprises ignition voltage pulses with the first polarity and ignition voltage pulses with the second polarity. The welding device is thus easy to handle and ensures reliable, contactless striking of the arc for different materials and parameters.

In an advantageous manner, an internal database with stored sequence patterns for different materials and/or surfaces can be stored in the welding device—in particular, in an open-loop and/or closed-loop control unit of the welding device.

Advantageously, the internal database can be at least partially synchronizable with an external database in which sequence patterns are stored, wherein the welding device can be configured to establish at least temporarily a connection to an external memory and/or a network and/or a cloud in which the external database is stored. In this way, the knowledge gained and improvements developed with the welding device can also be used for other, similar welding devices, and vice versa.

In a further advantageous embodiment, at least one stored sequence pattern can be programmable by the user via an input or output unit. This allows, in particular, very experienced and trained users to specifically adapt the welding device to their own conditions.

In an advantageous manner, a currently selected sequence pattern can be displayed via a user interface or via an input and output unit. The display can, for example, take place based upon a designation of the sequence pattern or with the aid of a pictogram or a diagram-like representation. This makes it easier for the user to identify the selected sequence pattern and to recognize a previously successfully used sequence pattern.

Advantageously, at least one parameter that evaluates a quality and/or an ignition behavior of the sequence pattern used can be determined, wherein the determined parameter, where applicable, is stored and/or can be displayed via a user interface or via an input and output unit. This determination and management of the parameter(s) facilitates the implementation of quality assurance and enhancement mechanisms. Where applicable, the parameters can be compared with other empirical values via the synchronization and, where applicable, transmitted to the manufacturer, and can be used to implement targeted product improvements.

In a further preferred embodiment, the welding device is configured to apply an adaptive algorithm and to automatically select and adapt a sequence pattern suitable for optimal striking. In this way, the welding device “learns” based upon the “experience” and knowledge gained in use. The adaptive algorithm allows error sources to be identified and their solutions to be implemented automatically.

In the following, the present invention is described in greater detail with reference to FIGS. 1 through 7, which, by way of example, show advantageous embodiments of the invention in a schematic and non-limiting manner. In the drawings,

FIG. 1 shows a block diagrammatic representation of a welding device,

FIG. 2 shows a diagram of exemplary voltage and current profiles when an arc is struck at the negative pole,

FIG. 3 shows a diagram of exemplary voltage and current profiles when an arc is struck at the positive pole,

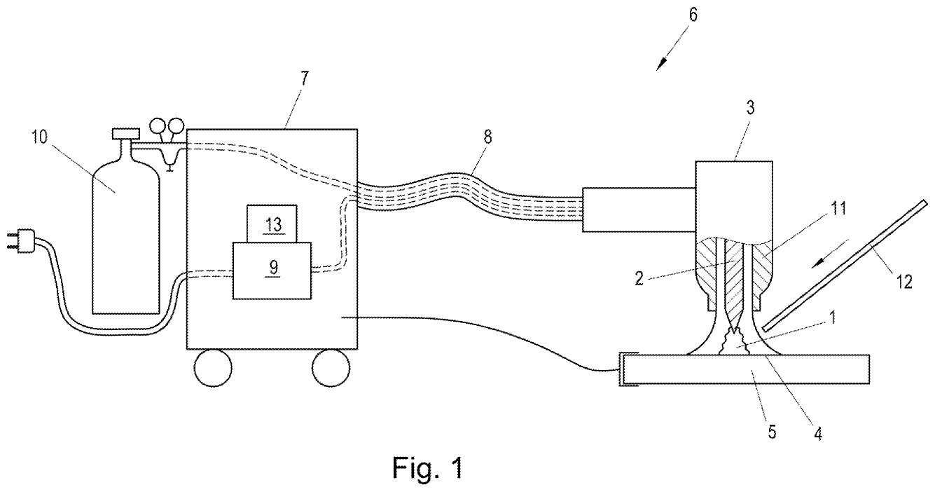

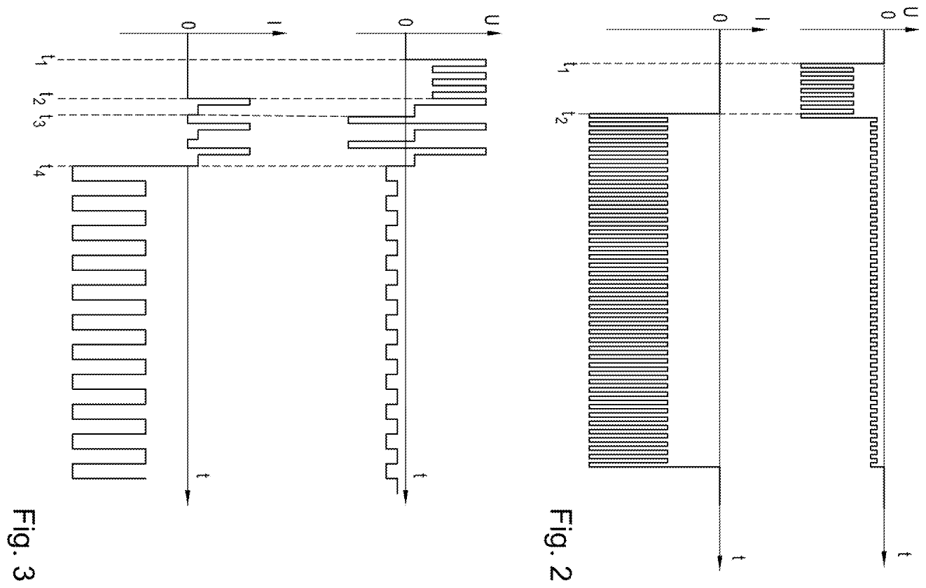

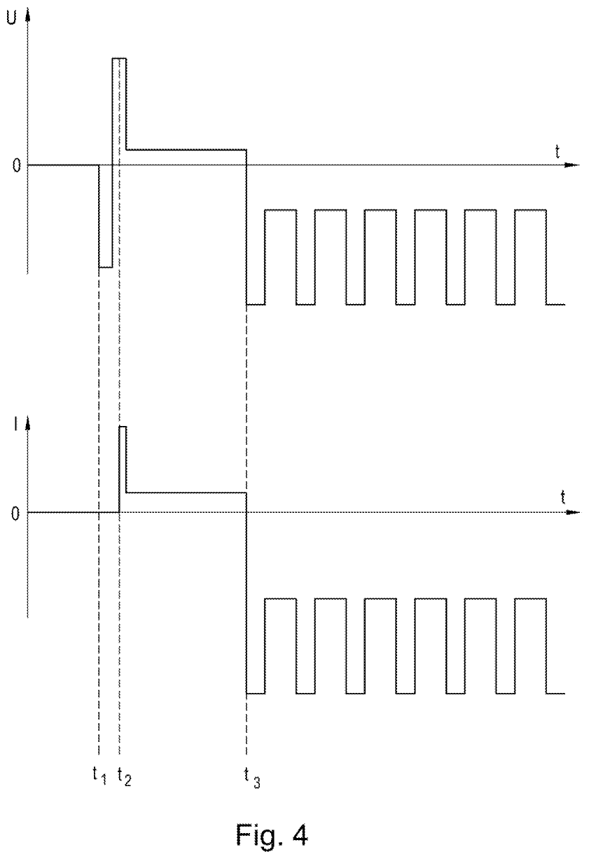

FIG. 4 shows a diagram of exemplary voltage and current profiles during the striking of an arc with a sequence of ignition voltage pulses starting with a negative pulse, and

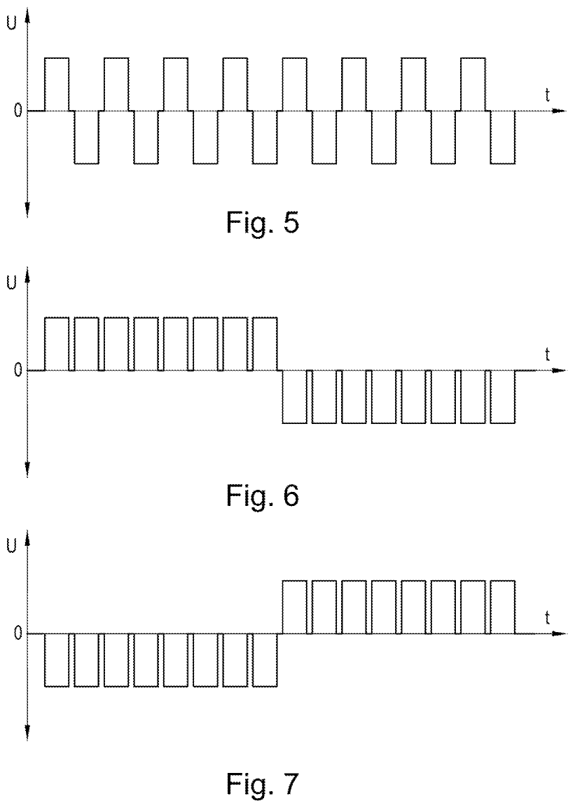

FIG. 5 through FIG. 7 show diagrams of sequences of ignition voltage pulses according to different sequence patterns.

FIG. 1 shows a schematic diagram of a welding device 6 with a supply unit 7 and a welding head 3, which is connected to the supply unit 7 via a hose assembly 8. The supply unit 7 has at least one welding current source 9 and at least one shielding gas source 10 in a manner known per se.

The welding head 3 has a non-melting electrode 2 and a shielding gas nozzle 11. An arc 1 burns between the electrode 2 and a workpiece 5 during welding and is struck, controlled, and maintained according to a set welding schema by the welding current source 9. For open-loop and closed-loop control, the welding current source 9 can be connected to an open-loop and/or closed-loop control unit 13. During welding, the shielding gas flows through the shielding gas nozzle 11 and surrounds the arc and protects the weld pool generated by the arc against undesirable influences of the ambient air. For example, argon, helium, and mixtures thereof, as well as argon with small amounts of nitrogen and oxygen, can be used as shielding gases.

Furthermore, inert, reducing, and oxidizing gas mixtures can also be used. For example, the proportion of hydrogen in a gas mixture may be up to 5 vol %. If necessary, the welding head 3 may also have a more complex structure. For example, the welding head 3 may be configured as a plasma welding head, which may have a usually cooled plasma nozzle for constricting the arc. Where applicable, the shielding gas supply and/or the shielding gas composition can also be subjected to open-loop and/or closed-loop control via the open-loop and/or closed-loop control unit 13.

During welding, a filler metal 12 is advanced manually or via an automated feed into the region heated by the arc, wherein the filler metal 12 melts off and, together with the molten material of the workpiece 5, forms the weld pool which forms the weld seam during hardening. The welding head 3 can be guided either manually or automatically—for example, by means of a welding robot. The filler metal can also be added either manually or with the aid of an automatic welding wire feeder, the feed rate of which is matched to the movement of the welding head 3.

Before each welding process, the arc 1 must be struck contactlessly, since the non-melting electrode is not to come into contact with the workpiece surface. If the non-melting electrode, which is usually a pure tungsten electrode or a tungsten electrode provided with oxide additives, were to come into contact with the material surface, tungsten inclusions or tungsten residues would be found in the material surface or in the weld seam. Striking is usually performed with the aid of ignition voltage pulses applied by the welding current source 9 between the electrode 2 and the workpiece 5. The contactless striking of the arc 1 is described in greater detail below.

Once the arc 1 is stably burning, (which is detected by the welding current source 9 by an increase in welding current), the arc 1 is maintained according to a selected welding schema, wherein the welding schema may specify, for example, the use of an arc with constant current or constant power, as well as a pulsed arc (both representing DC welding processes) or AC arc (AC welding process).

FIGS. 2 through 4 each show diagrams in which the profiles of the welding voltage U and of the welding current I before, during, and after striking of the arc are compared.

FIG. 2 shows a striking of the arc at the negative pole. The ignition process begins at time t1, wherein a sequence of negative ignition voltage pulses is applied between the electrode 2 and the workpiece 5 to strike the arc. This type of striking with negative ignition voltage pulses at the electrode is also referred to as “negative ignition.” The ignition process can be initiated, for example, by pressing a torch button (in the case of manual welding) or by a machine control (in the case of machine welding). In the case shown as an example, the arc strikes only after a considerable delay, viz., with the seventh ignition voltage pulse (time t2). If, for example, ignition voltage pulses have a length of 5 ms each and are applied at a frequency of 100 ignition voltage pulses per second, this corresponds, in FIG. 2, to an ignition delay of 70 ms. Although such an ignition delay can already be perceived by the user, it is generally not yet perceived as annoying. Nevertheless, the ignition delay is an indication that the ignition process is not optimal for the given welding task.

At the seventh ignition voltage pulse, the arc 1 typical of the welding process is formed at time t2 in the ionized region generated by the ignition voltage pulses between the electrode 2 and the workpiece 5 and can be recognized in the current profile by a sharp (negative) increase in the welding current I. The welding current source 9 detects the ignition of the arc on the basis of the welding current profile and does not generate any further ignition voltage pulses, but controls the further welding process in accordance with the selected welding schema, i.e., for example, with a constant welding current or a constant power, or, as in the case shown, with a variable welding current applied in the form of welding pulses, wherein a pulsed arc is generated. Where applicable, the welding schema can also be continued with alternating current (AC welding process), as can be advantageous, for example, when welding aluminum and its alloys or also magnesium and its alloys. A typically set AC frequency for TIG welding of aluminum, magnesium, and their alloys is 100 Hz.

When the arc is struck at the negative pole (i.e., in the case of negative ignition), the electrons migrate from the electrode 2 into the workpiece, so that the heat is generated mainly in the workpiece, which is also desirable for the formation of the weld pool. The electrode 2 heats up to a lesser extent and is thus protected from excessive wear. A disadvantage of negative ignition is that the arc often does not burn very stably at the start of welding and that noticeable ignition delays can occur with certain welding materials. An ignition delay of more than half a second is already considered annoying by most users. Potentially, also complete ignition failures can occur, in which case the arc does not strike at all in an ignition voltage pulse sequence of a specified length. The length of the sequence of ignition voltage pulses can be specified, for example, by safety regulations and standards or by the capacities of the welding current source 9, depending upon operations.

In order to increase the reliability of striking and the stability of the arc after striking, an alternative ignition process has been developed in which striking takes place at the positive pole. Since the welding process itself is usually performed with negative polarity, the arc, for welding, usually still has to undergo a polarity reversal to the negative pole once it is burning stably. FIG. 3 shows an exemplary profile of the welding voltage U and welding current I for such an ignition process at the positive pole, which is also referred to as “reversed polarity ignition” (RPI ignition). In the case of striking at the positive pole, the workpiece surface is “cleaned” to a certain extent by the exiting electrodes—for example, by oxide deposits being stripped from the surface. When striking at the positive pole, the temperature at the tungsten electrode rises, which makes it easier to strike the arc.

The ignition process shown in FIG. 3 starts at time t1 with a sequence of positive ignition voltage pulses, wherein, with the fourth ignition voltage pulse (at time t2), an arc strikes, which can be seen by the increase in (positive) welding current. After striking of the arc, the welding voltage and welding current are maintained with positive polarity for a short warm-up period (for example, about 10 to 20 ms), after which the polarity is reversed to the negative pole. In FIG. 3, the warm-up period extends from the end of the ignition voltage pulse to time t3. It may be that the arc is extinguished again during the polarity reversal, which is the case in FIG. 3 at time t3. Therefore, a positive ignition voltage pulse follows again, which strikes an arc; this is maintained again for a warm-up period at the positive pole, and then the polarity is reversed again to the negative pole, wherein the arc is extinguished again in the example shown. Only after the third striking of the arc at the positive pole and a further warm-up period is the polarity reversed to the negative pole at time t4, and the actual welding process can be carried out according to a selected welding schema. FIG. 3 shows the welding schema as a pulse welding process, but welding can also be carried out with constant direct current or with constant power or with alternating current (AC welding process).

If striking is carried out with the tungsten electrode at the positive pole, this can improve the reliability of the striking and arc stability when starting the weld. However, it might not be possible to reverse the polarity of the arc, and it may go out again. As electrons travel from the workpiece to the electrode during positive pole ignition, the electrode tip heats up considerably, accelerating its wear. If the arc polarity cannot be reversed, the electrode tip is nevertheless subjected to high stress by the striking positive arcs.

Particularly with smooth, polished surfaces, striking at the positive pole can be difficult. For example, when welding high-alloy and low-alloy steels, as well as non-ferrous metals, or in the case of re-ignitions at the same spot weld or overlapping spot welds at the positive pole, ignition misfires may occur because the very smooth workpiece surfaces that feature in this process worsen the ignition behavior at the positive pole. The optimal selection of the ignition process depends upon numerous material properties and parameters, such as surface roughness, chemical composition of the material, crystallography and grain size and distribution, coating, etc. The selection of the right ignition process is a complex task; in some cases, it may also be that the circumstances change during welding, e.g., a previously selected and optimally functioning ignition process may suddenly no longer work—for example, if a weld is to be continued at a previously made seam.

FIG. 4 shows the profile of the welding voltage U and the welding current I during an advantageous ignition process which always ensures optimum ignition reliability, irrespective of the particular material properties and parameters. In this process, a sequence of ignition voltage pulses is generated until the arc is struck, which comprises ignition voltage pulses with the first polarity and ignition voltage pulses with the second polarity. In the case shown, a first, negative ignition voltage pulse is applied first, at time t1. If this immediately strikes an arc, the process continues in the manner shown in FIG. 2. If, as in the case shown, the first ignition voltage pulse does not cause an arc, the first ignition voltage pulse is immediately followed (possibly with a predetermined delay) by a second ignition voltage pulse with reversed, positive polarity, with which an arc strikes at time t2. The arc is then again maintained for a warm-up period, and the polarity is reversed at time t3. This is followed in turn by the conventional welding process according to the selected welding schema.

In FIG. 4, the arc strikes already at the second ignition voltage pulse. However, it can also take longer for striking to occur. In this case, the ignition process is continued by the previously defined sequence of positive and negative ignition voltage pulses until successful striking is achieved. The sequence corresponds here to a defined sequence pattern which defines the positive and negative ignition voltage pulses.

After time t3, FIG. 4 shows a sequence of welding voltage pulses (FIG. 4 top) and welding current pulses (FIG. 4 bottom) in welding mode, after successful ignition of the arc has taken place at time t2. By way of example, a pulse welding method (pulsed DC welding process) is shown, comprising a sequence of welding voltage pulses and welding current pulses. In the pulsed welding process shown, welding voltage pulses (FIG. 4 top) and welding current pulses (FIG. 4 bottom) are provided, which are interrupted by intermediate welding phases. In the intermediate welding phases, the welding voltage/welding current is reduced to a lower base welding voltage/base welding current. The base welding voltage/base welding current can also be zero in the intermediate welding phases. The welding voltage pulses (FIG. 4 top) and welding current pulses (FIG. 4 bottom) can occur with a frequency in the range of 0.1 Hz to 10 kHz.

Although FIG. 4 shows a pulsed DC welding process, a constant current welding process (unpulsed DC welding process), an AC welding process, or a combination of AC welding process and DC welding process—a so-called AC-DC mix welding process—can also be used from time t3 on.

An AC-DC mix welding process comprises welding phases in which a—preferably pulsed—DC welding process is performed, and welding phases in which an AC welding process are performed. Accordingly, an AC-DC mix welding process can mean that, during the welding process, a plurality of welding voltage pulses with a first polarity occur (e.g., a pulsed DC welding process segment with a first polarity), whereupon a polarity reversal of the welding voltage to another, second polarity takes place (an AC welding process segment), and, again, a plurality of welding voltage pulses with this other second polarity occur (a pulsed DC welding process segment with a second polarity), whereupon a polarity reversal of the welding voltage takes place again, and so on.

However, an AC-DC mix welding process can also mean that, after an occurrence of a plurality of welding voltage pulses with a first polarity (e.g., a pulsed DC welding process segment with a first polarity), the polarity of the welding voltage is reversed several times—first to a second polarity, then back to the first polarity, then, if necessary, back to the second polarity again, and so on (AC welding process segment), and only after a multiple polarity reversal does a plurality of welding voltage pulses of the same polarity occur again with the then given polarity (e.g., a pulsed DC welding process segment). The type of welding process can be selected according to the welding task to be performed.

In this method, if an arc ignited at the positive pole goes out again during the polarity reversal, either the defined sequence of ignition voltage pulses already started can be continued with the ignition voltage pulse provided next in the sequence pattern, or the sequence can be restarted according to the same or a modified sequence pattern.

In the context of the present disclosure, the term, “sequence pattern,” refers to the definition of at least the polarities of the ignition voltage pulses that follow one another in a sequence. If necessary, the sequence pattern can also define other parameters, wherein the other parameters can be selected, for example, from amplitudes of ignition voltage pulses, intervals between each two ignition voltage pulses, and a maximum length of the sequence.

FIGS. 5 through 7 show different exemplary sequence patterns by way of example.

FIG. 5 shows a sequence of ignition voltage pulses in which, starting with a positive ignition voltage pulse, a positive followed by a negative ignition voltage pulse is alternately executed. Similarly, the sequence pattern shown in FIG. 5 can also start with a negative ignition voltage pulse.

FIG. 5 shows an ignition pause between two successive ignition voltage pulses of different polarity. An ignition pause is defined here as the time interval during which the ignition voltage is zero during the change from an ignition voltage pulse of a first polarity to an ignition voltage pulse of a second polarity (or vice versa). As mentioned, ignition pauses (occurring with a zero-crossing) can be used to check whether an arc has already been struck. Such ignition pauses are, advantageously, to be kept short. Typically, such ignition pauses have a duration between 50 μs and 0.1 μs; preferably, the duration for an ignition pause is between 20 μs and 0.2 μs, and particularly preferably between 10 μs and 0.5 μs.

Since the ignition pauses can be very short, as mentioned above, in FIG. 4, no ignition pause is shown during the transition from the initially negative ignition voltage pulse from time t1 to the then positive ignition voltage pulse. The ignition pause, not shown graphically, occurs in FIG. 4 between times t1 and t2. The welding phases shown in FIG. 4 from time t3 onwards, where the welding voltage/welding current is reduced to a lower base welding voltage/base welding current during welding operation, are, as mentioned, to be understood, in contrast, as intermediate welding phases and can therefore be clearly distinguished from ignition pauses.

As mentioned, ignition pauses (occurring with a zero-crossing) can be used to check whether an arc has already been struck.

FIG. 6 shows a further advantageous sequence pattern in which in each case a fixed number of positive ignition voltage pulses, spaced by means of intermediate ignition phases, are executed, followed by a fixed number of negative ignition voltage pulses, spaced by means of intermediate ignition phases. Since no polarity changes take place within a number of positive ignition voltage pulses or within a number of negative ignition voltage pulses, the intervals between ignition voltage pulses of only one polarity, referred to as intermediate ignition phases, do not represent ignition pauses in the sense of the present invention.

In the case shown in FIG. 6, eight positive ignition voltage pulses, each spaced by means of intermediate ignition phases, are followed by eight negative ignition voltage pulses, each spaced by means of intermediate ignition phases, and this sequence can be repeated if necessary until a maximum length is reached. FIG. 6 also shows an ignition pause according to the invention between two adjacent ignition voltage pulses of different polarity (center of diagram).

FIG. 7 shows an analogous sequence pattern which differs only in terms of polarity and begins with eight negative ignition voltage pulses spaced by means of intermediate ignition phases, followed by eight positive ignition voltage pulses spaced by means of intermediate ignition phases. Analogously to FIG. 6, FIG. 7 also shows an ignition pause according to the invention between two adjacent ignition voltage pulses of different polarity, wherein the polarity change takes place in the opposite direction here compared to FIG. 6.

The intermediate ignition phases between the positive ignition voltage pulses can be of the same or different length as the intermediate ignition phases between the negative ignition voltage pulses. Such intermediate ignition phases can have a wide variety of durations, and can last, for example, a relatively long time between 50 ms and 5 ms, a relatively short time between 5 ms and 50 μs, or a very short time between 50 μs and 0.1 μs. When selecting these durations, national or international standards and regulations can be taken into account, in addition to conditions for striking the arc.

The number of successive ignition voltage pulses of the same polarity in the sequence pattern can also be higher or lower than shown in FIG. 6 or 7. Where applicable, the number of successive ignition voltage pulses of the same polarity may also change within a sequence pattern, or the number of successive ignition voltage pulses with positive polarity and those with negative polarity may differ from each other. If necessary, the total number of ignition voltage pulses with positive polarity may differ from the total number of ignition voltage pulses with negative polarity, or they may be identical.

In the cases shown in FIGS. 5 through 7, the individual ignition voltage pulses each have the same (positive or negative) amplitude and the same duration, and the time interval between each two successive ignition voltage pulses is identical in each case. However, it is also possible to define sequence patterns in which the successively executed ignition voltage pulses can also differ in a defined manner with regard to these parameters. With knowledge of the teachings disclosed herein, a person of average skill in the art is able to sensibly select suitable sequence patterns through routine work and tests, taking into account the stated boundary conditions.

In all cases, the ignition voltage pulses are executed according to the corresponding sequence pattern until either an arc strikes or a maximum duration or maximum number of ignition voltage pulses defined for the sequence pattern is reached, and the process terminates without striking.

The individual features and variants specified in the individual configurations and examples can (unless otherwise stated then and there) be freely combined with those of the other examples and configurations, and can be used in particular to characterize the invention in the claims, without necessarily including the other details of the respective design or the respective example.

### LIST OF REFERENCE SIGNS

arc 1
electrode 2
welding head 3
material surface 4
workpiece 5
welding device 6
supply unit 7
hose assembly 8
welding current source 9
shielding gas source 10
shielding gas nozzle 11
filler metal 12
open-loop and/or closed-loop control unit 13

1. A method for contactlessly striking an arc between an electrode of a welding head and a material surface of a workpiece for a welding process, wherein a first ignition voltage pulse with a first or second polarity is generated between the electrode and the material surface, wherein, after having been struck and, where applicable, after a polarity reversal, the arc is maintained with the second polarity or with an alternating polarity, wherein, in the event of an ignition failure, after the first ignition voltage pulse, a sequence of ignition voltage pulses is generated according to a sequence pattern until successful striking of the arc, wherein the sequence pattern comprises a number of ignition voltage pulses with the first polarity and a number of ignition voltage pulses with the second polarity, and wherein an ignition pause is provided between ignition voltage pulses with the first polarity and ignition voltage pulses with the second polarity.

2. The method according to claim 1, wherein the sequence pattern is defined by an alternating sequence of an ignition voltage pulse with the first polarity followed by an ignition voltage pulse with the second polarity, or vice versa.

3. The method according to claim 1, wherein the sequence pattern is defined by a first fixed or variable number of ignition voltage pulses with the first polarity followed by a second fixed or variable number of successive ignition voltage pulses with the second polarity, or vice versa.

4. The method according to claim 1, wherein, when the arc is struck following an ignition voltage pulse with the first polarity, the are is maintained for a warm-up period with the first polarity, after which the polarity is reversed to the second polarity.

5. The method according to claim 4, wherein, if the arc is extinguished during the polarity reversal, the previously started sequence of ignition voltage pulses is continued in accordance with the sequence pattern.

6. The method according to claim 1, wherein at least one parameter that evaluates a quality and/or an ignition behavior of the sequence pattern used is determined, wherein, where applicable, the determined parameter is stored and/or is displayed via a user interface or via an input and output unit.

7. The method according to claim 6, wherein, if the parameter falls below or exceeds or reaches a previously defined limit value, an alternative sequence pattern is automatically selected.

8. The method according to claim 7, wherein the alternative sequence pattern is either randomly selected from several sequence patterns or is generated with the aid of an optionally adaptive algorithm.

9. The method according to claim 1, wherein the welding process is an AC welding process.

10. The method according to claim 1, wherein the welding process is a DC welding process.

11. The method according to claim 9, wherein the contactless striking of the arc occurs during the welding process.

12. The method according to claim 1, wherein the contactless striking of the arc occurs at the start of the welding process.

13. The method according to claim 1, wherein, in the sequence pattern, the ignition voltage pulses undergo a polarity reversal twice.

14. A welding device with a welding head, on which there is provided an electrode, wherein the electrode is connected to a supply unit by which a voltage can be applied in controlled fashion between the electrode and a material surface of a workpiece, wherein the supply unit is configured, for contactless striking of an arc between the electrode and the material surface, to produce a first ignition voltage pulse with a first or second polarity and to maintain the arc with the second polarity after having been struck and, where applicable, after a polarity reversal, wherein the supply unit is further configured, in the event of an ignition failure, after the first ignition voltage pulse until successful striking of the arc, to generate a sequence of ignition voltage pulses according to a sequence pattern, wherein the sequence pattern comprises a number of ignition voltage pulses with the first polarity and a number of ignition voltage pulses with the second polarity, and wherein an ignition pause is provided between ignition voltage pulses with the first polarity and ignition voltage pulses with the second polarity.

15. The welding device according to claim 14, wherein an internal database containing stored sequence patterns for different materials and/or surfaces is stored in the welding device, in particular in an open-loop and/or closed-loop control unit of the welding device.

16. The welding device according to claim 15, wherein the internal database is at least partially synchronizable with an external database in which sequence patterns are stored, wherein the welding device is configured to establish at least temporarily a connection to an external memory and/or a network and/or a cloud in which the external database is stored.

17. The welding device according to claim 14, wherein at least one stored sequence pattern is programmable by a user via an input or output unit.

18. The welding device according to claim 14, wherein a currently selected sequence pattern can be displayed via a user interface or via an input and output unit.

19. The welding device according to claim 14, wherein at least one parameter that evaluates a quality and/or an ignition behavior of the sequence pattern used can be determined, wherein the determined parameter, where applicable, is stored and/or can be displayed via a user interface or via an input and output unit.

20. The welding device according to claim 14, wherein the welding device is configured to apply an adaptive algorithm and to automatically select and adapt a sequence pattern suitable for optimal striking.
